(19) United States
(12) Patent Application Publication
(10) Pub. No.: US 2006/0288646 A1
(43) Pub. Date: Dec. 28, 2006

(54) Universal attachment assembly for clamping and bracing covers over openings

(76) Inventor: Frank M. Pleasants, Dawsonville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/448,288

(22) Filed: Jun. 7, 2006

Related U.S. Application Data
(63) Continuation-in-part of application No. 10/698,085, filed on Nov. 3, 2003, now Pat. No. 7,100,329.

(51) Int. Cl. E06B 3/26

(52) U.S. Cl. 49/465; 52/202

(57) ABSTRACT

A universal attachment assembly system and method comprising a pair of clamping levers, a tension delivery member, and a tension adjustment member, wherein the tensile pulling force delivered to each clamping lever is directionally changed, via the fulcrum, into a compressive force, thereby facilitating secure placement and seating of the universal attachment assembly in a selected position relative for a plurality of uses, including but not limited to securing a planar covering over an opening and bracing a framed structure expanse.

### CROSS-REFERENCE TO RELATED APPLICATION

This application claims priority to, all benefit of and is a Continuation-in-Part of co-pending U.S. Non-Provisional Utility patent application Ser. No. 10/698,085, filed Nov. 3, 2003, entitled “Universal Attachment Assembly for Clamping and Bracing Covers over Openings.”

### FIELD OF THE INVENTION

The present invention relates generally to first class lever devices, and more particularly, to a universal attachment assembly system and method comprising a pair of clamping levers, a tension delivery member, and a tension adjustment member, wherein the tensile pulling force delivered to each clamping lever is directionally changed, via the fulcrum, into a compressive force, thereby facilitating secure placement and seating of the universal attachment assembly in a selected position. This invention is particularly suited for, although not limited to, attaching covers over openings, anchoring intermediate supports between covers, and securing braces behind weak covers, such as, for exemplary purposes only, to attach shutters over windows and door openings, to anchor structural columns to brace garage doors, and to provide intermediate support for shutters during hurricanes. Hereinafter, one of the most severe and dramatic applications will be used to represent all applications—that of the protection of one's home at the approach of the hurricane; however although conveniently described in such a preferred use, the system and device of the present invention is suitable and could be utilized for securing cargo containers and/or any other suitably constructed, generally framed structure.

### BACKGROUND OF THE INVENTION

The down sides and obvious cost and damage due to hurricanes is common knowledge. The reader is referred to most all patents on the subject for this background and it will not be repeated herein.

Concrete is known and well documented in history as an excellent material in compression. However, in structural uses concrete has zero allowable strength in tension. Only metallic inserts, which create diagonal compression in the creation of a shear cone about the fastener, are attributed to producing tensile attachment. To exacerbate this problem, concrete is friable and subject to crumbling when exposed to cyclical compressive and tensile loading as by the turbulent winds of a hurricane. And yet, most buildings constructed close to ocean shores are concrete.

Thus, the problems are apparent with respect to available modes of attachment for protective barriers to be installed on such structures. How does one generate a resiliently soft but strong compressive force and eliminate the tensile forces as is required by the inherent nature of concrete? And further, how does one transfer this to the violently, fluctuating turbulent loads as generated by hurricane winds? And all the while, economics, ease of handling and speed of installation over a wide diversity of sites and shapes of openings must be provided. This is precisely the teaching of the present invention.

Tensile forces lead to expansion, wherein the length of a material increases in the direction of the pulling forces of the tension, and wherein volume remains constant, until the stress limit is reached and breakage occurs. Nails, bolts and anchors are structural members that are in direct tension during use. Compressive forces are opposing to tensile forces, and as such tend to compact materials. Thus, it is the exploitation of the inherent nature of concrete and its great compressive strength that enables the present invention to address and overcome the disadvantages in presently existing attachment assemblies.

The predominant direction of technology and investment is currently to create better inserts for concrete. That is, to try to pack tremendous resiliency in the small clearances between the concrete and the insert, in an effort to increase the tensile strength of the inserts to attempt to overcome the tensile limitations of concrete. All the while, these devices are making bigger scars on the face of buildings. The approach is generally accompanied by permanent mounting tracks or rails around the openings to further distract from the appearance of the home. (Ref. US2003/0134091 AL etc.) In addition to the aesthetic disadvantages, generally complicated installation is necessary.

Further, even with the realization of stress distribution and resultant increase in strength from such tracks or rails, installations of these critical devices can be prone to error as witnessed by the following recent example. It is no accident that after the landfall of the second tropical storm of 2003 in the USA, in Texas, one of the greatest costs of damage was attributed to failed inserts into concrete. Vibration loosened the inserts and the winds ripped off shutters, burst windows, and flooded the buildings with heavy rains. And this was only a class 1 hurricane.

Even if the insert stays in, a tremendous disadvantage with inserts is that threaded metal female inserts or threaded studs are left permanently mounted outdoors exposed to salt spray, rain, and dusty environments, or, potentially worse, covered with paint. Even stainless steel in this application is subject to galling and cross threading, and galvanized steel is no better. None of these disadvantages and concerns is comforting when a hurricane is rapidly approaching.

Recognizing the limitations of tensile strength dependent systems, U.S. Pat. No. 5,579,604 to Holung et al. describes the approach of mounting a compressive device inside an opening and using compression to secure a covering thereover. Even still, the compressive device therein described is disadvantageous in view of the present invention, wherein the Holung et al device requires a complicated gear/lock mechanism for delivery and maintenance of the compressive force.

Further, a great problem with all previous related devices is that compressive members over large spans are subject to buckling or collapse due to bending. Therefore, compressive members must be laterally braced and or increased in mass and cross-section to prevent buckling. This results in more weight and complexity, and therefore increased cost and potential for failure. Moreover, greater weight and complexity, in turn, increases the difficultly and time of installation.

One final problem in installing attachment assemblies to buildings relates to the lack of detents or shallow holes in the sidewall of a building's openings. Concrete block construction is almost universally finished with stucco. Initial tests on the present invention revealed that most stuccoes crumble under compression and shears off the surface. This leaves sand and chips of debris, which act as a lubricant similar to gravel on a curve in a road. It is thus necessary to at least penetrate the finish layer and expose solid aggregate to rest the compressive member on. However, additionally, the addition of a slight ridge for the compressive foot to rise over assures that this will not be the weakest link in the design.

The present invention relies on the rigidity of the shutter or covering to carry the compressive force. The limiting requirement of a shutter is not its strength, but the deflection required by codes. Therefore the specific requirements of each type of material, be it plywood, corrugated steel, plastic or aluminum, vary and the allowable spans must be evaluated separately. In any event, such panels are already designed for stiffness and a small limitation of span or increase of metal gauge is the only consequence, depending on the class of hurricane and wind speed being assumed for the geographic area.

A final point regarding inserts and anchors. They require full penetration of the concrete block's web and therefore frequently introduce leakage paths for water to travel to the core of the block. Disadvantageous effects on indoor air quality and increased mold potential are only now beginning to be recognized and addressed. However, the small shallow dents as required by the present invention are only approximately ⅓ to 1/2 of the depth of the wall of the block, thus avoiding the creation of such pathways. When painted like the wall and located on the side of the wall rather than the face of the wall, such installation dents are virtually invisible with no concern of corrosion, thread damage, or contamination of interior air quality.

Therefore, it is readily apparent that there is a need for a system and method for attachment assembly, wherein the incorporation of a lever ensures that tensile forces are minimized and compressive forces are maximized, wherein permanent installation of base members is not necessary, and wherein simplicity of components facilitates quick and easy installation and removal and cost-effectiveness, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing an attachment assembly for the connection and installation of covers of all types over openings of all types without defacing the surface of the openings.

According to its major aspects and broadly stated, in its preferred form, the present invention is a universal attachment assembly for clamping and bracing covers over openings, wherein the simplicity of design and operation of the unique lever system, the economy of the assembly components, the realized resistance to vibration, and speed of installation and removal are but a few of the beneficial characteristics of this invention.

More specifically, the device of the present invention in its preferred form is an attachment assembly comprising a series of force-generating and directing components. First, a tensile latching force is generated, preferably by an inexpensive, commercially available ratcheting device. This tensile force is transmitted, either across the width of a generally planar cover or along the length of a structural column, by inexpensive, lightweight straps. Because the tensile generating device is located between the fulcrum points of the cover panel or reinforcing column, the materials required to transfer the forces are only a very light, flexible, and inexpensive strap. Only then are the rigid and strong levers necessary to operate in cooperation with the cover to result in compression against the structure of the opening. Thus, the mounting of the attachment assembly is accomplished by simply defining throughholes at the margin of the panel and inserting levers to convert tensile forces outboard of the shutter to compressive forces bearing on the concrete inboard of shutter. The lever fulcrums are positioned proximate the throughhole of the shutter or cover, with a pulling force from the tensile generating device transferred via the straps to the lever and converted thereby to a compressive force delivered to structure bearing the opening to be covered.

The geometry of the various load points of the lever and the location of the fulcrum generate an acute angle of the force vector relative to the panel. This clamps a portion of concrete between the lever and the shutters and snugs the shutter or panel against the outside face of the opening. On thin metal or plastic panels, a grommet may be utilized about the fulcrum hole to relieve stress concentrations and potential deformation of the panel material by uniformly distributing the point load over a larger area of the panel.

Further, the invention efficiently uses the inherent elasticity of the straps to provide constant compression of the levers against the concrete regardless of the turbulent buffeting of the winds. By initially preloading the straps in tension, a large compression force is superimposed over the cyclical loads. Therefore the resultant load is a varying compressive load. This totally eliminates the need for the unattractive inserts and their frequent failure. This concept is well proven by the use of this type of apparatus in cargo clamps on exposed trucks or trailers.

The present invention may also be used, without modification, in a closely related application of the ratcheting strap type tensioning system. This additional device is a structural column to be used as an intermediate support for spanning of long architectural openings by shutters or other coverings. Such columns may also be utilized to brace garage doors. This application, in its preferred configuration, consists of structural 2″ thick lumber, a plurality of clamp assemblies and metallic termination angles. Unlike the throughholes of the planar coverings discussed hereinabove, the columnar structural reinforcement utilizes the termination angles to provide a narrow fulcrum point for the levers. Such angles also function to convert what could potentially be an instable bending connection into a stable and strong shear connection. This columnar design provides the same advantages as described in the planar covering or shutter.

Thus, a feature and advantage of the present invention is its ability to exploit a first class lever design to overcome tensile strength deficiencies, while harnessing compressive strength benefits in typical concrete constructions in order to facilitate attachment thereto.

Another feature and advantage of the present invention is its ability to directionally change and convert the tensile pulling force delivered to each clamping lever into a compressive force, thereby facilitating secure placement and seating of the universal attachment assembly in a selected position.

Another feature and advantage of the present invention its ability to attach generally planar coverings over openings.

Yet another feature and advantage of the present invention is its ability to anchor intermediate supports between coverings.

Still another feature and advantage of the present invention is its ability to secure braces behind weak coverings.

Yet still another feature and advantage of the present invention is its ability to attach shutters over windows and door openings.

Still yet another feature and advantage of the present invention is its ability to anchor structural columns to brace garage doors.

Further yet another feature and advantage of the present invention is its ability to provide intermediate support for shutters during hurricanes.

Yet another feature and advantage of the present invention is its ability to facilitate attachment to concrete without the installation of metallic inserts.

Still another feature and advantage of the present invention is its ability to generate a resiliently soft but strong compressive force and eliminate the tensile forces as is required by the inherent nature of concrete.

Further still another feature and advantage of the present invention is its ability to provide an attachment assembly with a system and method that is economical, easy to handle, and speedy to install over a wide diversity of sites and shapes of openings.

Yet still another feature and advantage of the present invention is its ability to eliminate the need for scarring on the face of buildings.

Further yet another feature and advantage of the present invention is its ability to virtually eliminate the risk of vibrational failure.

And still another feature and advantage of the present invention is its ability to eliminate negative impact from exposure to salt spray, rain, dust, and/or paint.

A further feature and advantage of the present invention is its ability to rely on the rigidity of the cover, or structural column to transfer, via the lever fulcrum, the compressive force.

Still a further feature and advantage of the present invention is its ability to eliminate the need for full penetration of the concrete block's web, thereby avoiding the introduction of leakage paths and resultant disadvantageous effects on indoor air quality via increased mold potential.

Yet still another feature and advantage of the present invention is its ability to rely on compression delivery points that are aesthetically pleasing and virtually undetectable, thus facilitating the placement of covers of all types of openings without defacing the surface thereof.

Yet another feature and advantage of the present invention is its ability to be disassembled and transported for reassembly at a subsequent location.

Still yet another feature and advantage of the present invention is its ability to define a lightweight yet structurally sound attachment assembly.

Yet another feature and advantage of the present invention is its ability to provide a protective covering assembly that is capable of assembly and use without necessitating tools.

Still another feature and advantage of the present invention is its ability to provide a protective covering assembly that is capable of secure assembly and safe use without necessitating the incorporation of screws or fastening pins.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a detail of the specialized structural clamping lever, according to the preferred embodiment of the present invention, showing the direction of the pulling tensile force, showing the lever extending through a planar covering at the fulcrum point, and showing the direction of the resultant compressive force;

FIG. 2 is a side view of a universal attachment assembly, according to the preferred embodiment of the present invention;

FIG. 3 is a cross-sectional view showing a pair of shutters, an opening, a structural column assembly, and a plurality of universal attachment assemblies;

FIG. 4 is a perspective view of a structural column assembly, according to an alternate embodiment of the present invention;

FIG. 5 is a side view, taken along line 5-5 of FIG. 4, showing a termination angle of a structural column assembly;

FIG. 6 is a sectional view of grommets used in thin corrugated shutters of steel, aluminum or plastic;

FIG. 7 is a front perspective view of the universal attachment assembly of FIG. 2, showing installation and attachment of an exemplary covering for an exemplary framed opening demonstrated as a simulated window sill model formed by 2×4″ members;

FIG. 8 is a rear perspective view of the universal attachment assembly of FIG. 2, showing installation of levers through an exemplary covering for an exemplary framed opening demonstrated as a simulated window sill model formed by 2×4″ members;

FIG. 9 is a perspective view of the universal attachment assembly of the present invention, as used with the structural column assembly of FIG. 4, showing installation and exemplary bracing of an exemplary garage door; and

FIG. 10 is a prior art attachment assembly utilizing hooks.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

First, in order to clearly distinguish the benefits of the present invention, it may be instructive to describe at least one known prior art attachment assembly, as depicted in FIG. 10, and as described in U.S. Pat. No. 2,598,610 to Satz et al. It is pointed out that a combination of hooks, clips and eyebolts with permanently secured metal installation strips are required in order to assemble storm shutters according to the prior art. That is, although at first glance of the Satz et al. patent, and also of U.S. Pat. No. 6,195,848 to Jackson et al., some similarity to the present invention could be presumed because of the apparent presence of a curved attachment member, a flexible tensile force delivery member, and tension creator, none of the existing methodologies or assemblies are capable of functioning in the manner of the present invention, nor does any solve the problems addressed by the present invention. On the contrary, the Jackson et al. assembly exerts only tensile forces, with no conversion to compression, and the Satz et al. assembly relies upon permanently anchored installation plates to adapt the tensile force to a compressive force. Neither incorporates a lever, nor is capable of functioning as such.

By contrast, referring to FIGS. 1-9, the terminology utilized for representing generic fasteners for securing covers over openings is that of the typical application of storm shutters over windows and doors of buildings. While this provides visibility and familiarity of the configuration it is not intended to limit applicability of the present invention. Fabrication of all elements is intended to be substantially of commercially available practice now or as in the future and is not limited to the current materials or practices shown.

FIG. 1 is a detail of the preferred specialized structural clamping lever 10 of the present invention, wherein specialized structural-clamping lever 10 is preferably used to enable the capabilities of all following embodiments and assemblies. That is, it is clamping lever 10, a first class lever that facilitates the directional change of the tensile force to that of a compressive force. First end 11 preferably comprises eyelet 102, to enable attachment of clamping lever 10 to adjustable length tensioning assembly 100. Preferably, adjustable length tension assembly 100 comprises straps 22a and 22b, wherein preferably each strap 22a and 22b is adapted with a clamping lever 10. Unlike previously described “S” and “U”-shaped hooks, the unique structural characteristics of clamping lever 10 define central inflection point 13, wherein the arc of clamping lever 10 reverses in concavity, or inflection. Inflection point 13 functions as a fulcrum for clamping lever 10. Referring now to FIGS. 1, 3, 7 and 8, in use, inflection point 13 of clamping lever 10 is positioned proximate fulcrum hole 23, as defined through covering or shutter S, wherein clamping lever 10 extends therethrough to facilitate installation and attachment thereof over an opening.

Second end 12 of clamping lever 10 is preferably compressive force delivery point 104, bearing from inflection 106, a concavity opposing that of fulcrum inflection point 13. In use, second end 12 is preferably passed through fulcrum hole 23 of covering or shutter S, toward the interior of the structure opening, and preferably brought to bear on retainer hole 26, preferably defined into an opening frame, F, such as, for exemplary purposes only, a window casement, sill, door jam, or the like.

It will be noted that for maximum stability to exist in the loaded lever 10, the load point of the fulcrum hole 23 is preferably located to the right of a line of centers through the load points 17 of the two ends of lever 10, as shown in FIG. 1. The preferred positioning of adjustable length tension assembly 160 on first end 11 of lever 10, relative to inflection point 13 and also to compressive force delivery point 14, is enabled by the unique configuration of clamping lever 10, wherein this preferred configuration facilitates maximum stability. In this disclosure, lever 10 is preferably made of a bent and hardened steel rod. However, stamped, cast forged, or any other type of lever construction of any suitable material can be substituted if still compliant with the function and intent of lever 10 as herein described. Further, other guides, moment connections, or the like used to prevent rotation of the loaded lever could also satisfy the intent of the preferred embodiment.

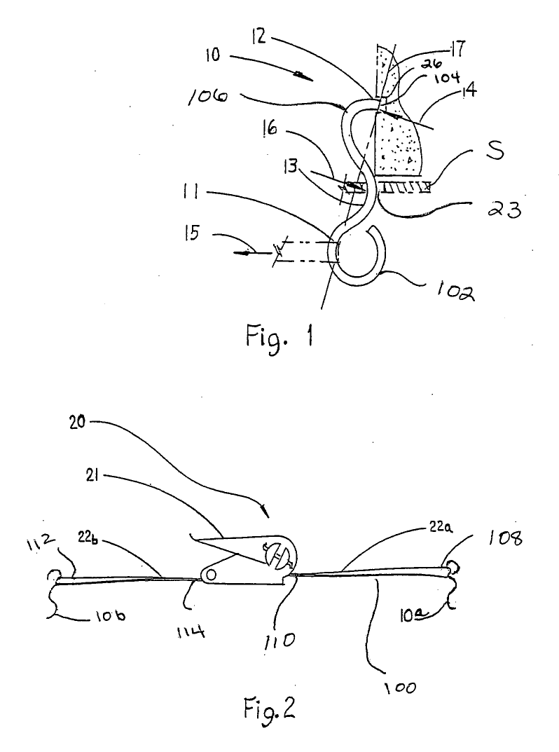

FIG. 2 is a side view of preferred universal attachment assembly 20, wherein commercially available ratcheting device 21 is preferably incorporated for adjusting the length of tensioning assembly 100 while also preferably generating a controlled and reliable tensile force, which is the present practice of almost all manufacturers of commercially available ratcheting device 21. A comparable assembly with hooks on the end rather than levers are the “Ratcheting tie-downs by “Workforce” which is the store brand of Home Depot, 2455 Paces Ferry Road, Atlanta, Ga. 30339. However, as noted hereinabove, such hook assemblies are incapable of operating as levers and are therefore unable to perform the function of the present invention. One skilled in the art should recognize that although ratcheting device 21 is the preferred means of adjusting the length of tensioning assembly 100 and of generating a controlled and reliable tensile force, other devices could be utilized, such as traditional prong buckles, frictional engagement buckles, loop engaging rings, locking extendable/retractable devices, cinch, and/or any other suitable device capable of generating and maintaining appropriate tension. Further, although straps 22a and 22b are preferred for tensioning assembly 100, any suitable tension transfer member could be utilized, such as rope, wire, springs, or any other appropriate member, in combination with an appropriate tension generating and maintaining device, including hydraulically adjustable cylinders. Preferably, an inherent elasticity of straps 22a and 22b provides resilience in maintaining constant, high, compressive loading against concrete sills and the like despite fluctuations due to turbulent wind loads.

In the preferred embodiment, first strap 22a of universal attachment assembly 20 connects at first end 108 to first end 11 of first lever 10b. Second end 110 of strap 22a is preferably free to be wrapped about the drum (not shown) of ratcheting device 21. Similarly, second strap 22b is securedly attached at its first end 112 to first end 11 of second lever 10b, and at its second end 114 to the body of ratcheting device 21. It is this unique combination of first class levers 10a and 10b, ratcheting device 21, and tensioning assembly 100 that defines the preferred universal attachment assembly 20 of the present invention, thereby enabling structural protection and/or reinforcement via directional conversion of tensile forces to compressive forces.

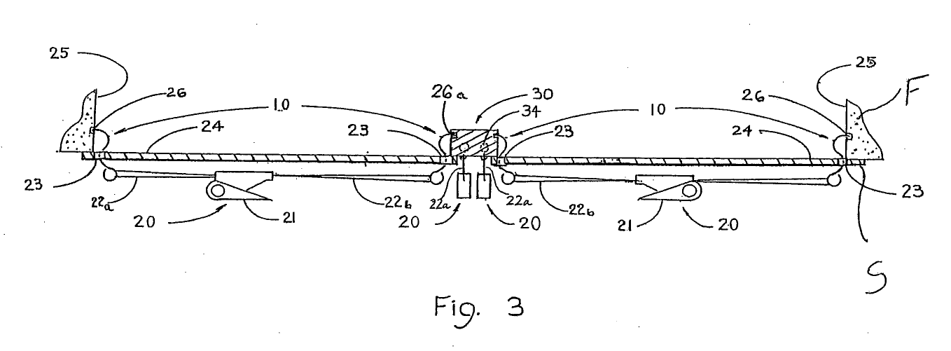

FIG. 3 is a cross-sectional view showing a pair of shutters, S, an opening, structural column assembly 30, and a plurality of universal attachment assemblies 20. That is, four universal attachment assemblies 20 are depicted in cooperative arrangement. First, paired fulcrum holes 23 are defined in the margin of each shutter S, designated covering 24. Each covering 24 can be almost any generally planar or corrugated panel or shutter, wherein two such coverings are depicted in FIG. 3, each covering 24 approximately one-half of the opening. Interior wall faces 25 of frame F are such items as window casements, sills, doorjambs, or the like, wherein retainer hole 26 is defined therein in order to receive compressive delivery point 104 of respective lever 10. Because FIG. 3 depicts an opening bearing a dimension greater than that able to be covered with one covering 24, FIG. 3 also includes structural column assembly 30, positioned between the pair of coverings 24 and essentially performing in place of frame F, in order to reinforce the covered opening. Thus, FIG. 3 depicts two different embodiments utilizing universal attachment assembly 20.

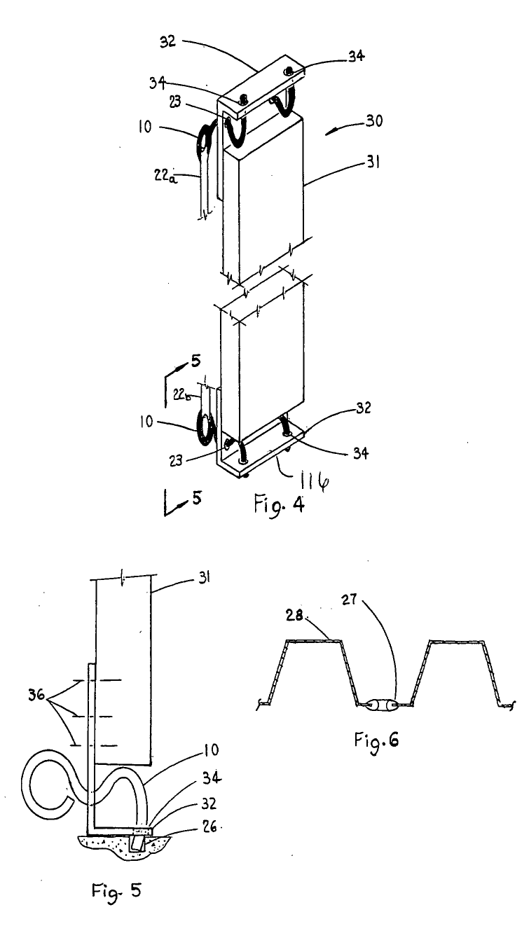

FIG. 4 is a perspective view of structural column assembly 30. FIG. 5 is a section through termination angle 32 of structural column assembly 30. Structural column assembly 30 provides strength and rigidity for large span openings, such as in use as a brace for a garage door, or as shown in FIG. 3, provides an intermediate support for shutters in architectural openings too wide to be economically spanned by a single shutter. Structural column 31 is the compression and bending-providing element of this embodiment, wherein structural column 31 is preferably made of lumber, or can also be constructed of structural metal, plastic, composite, or the like. Termination angle. 32 is attached to lumber structural column primarily to provide a narrow cross section at fulcrum hole 23 for inflection point 13, or fulcrum, of lever 10 to bear against. For other embodiments wherein structural column 31 is formed from metal, composite, or other materials, the necessary thickness of column 31, as dictated by material strength, may or may not require termination angle 32. That is, if structural column 31 is formed from materials of sufficient strength such that column thickness may be minimized in order to enable a narrow enough cross section at fulcrum hole 23, then termination angle 32 could be unnecessary and fulcrum hole 23 could be defined directly through structural column 31.

Termination angle 32 is preferably L-shaped bracket 116, securely fastened to each end of structural column 31. Preferably, the means of attachment for L-shaped bracket 116 to structural column 31 are typical fasteners 36, such as, without limitation, screws or bolts. Although such a configuration is preferred, integral formation, such as with a composite or steel structural column, could also be utilized. Alignment holes 34 defined in L-shaped bracket 116 provide guides and shear connection to the frame being supported, such as to a garage floor and roof structure, wherein alignment holes 34 are functionally related to retainer holes 26 of the panel retention embodiment described hereinabove, wherein compressive force delivery point 104 of lever 10 extends therethrough. Alignment holes 24 thus provide guidance and retention of lever motion.

It should be noted that supplemental structures may be necessary to facilitate attachment of structural column 31 to garage ceilings, depending on site-specific conditions. That is, the length of column assembly 30 should be adjusted for a slip fit or preferably a light force fit between faces of the openings in which column assembly 30 is installed in order to provide a sheer connection. A pair of slotted holes for receiving fasteners 36 may be utilized to facilitate this adjustment.

FIG. 6 is a section view of grommets 27 used in thin corrugated shutters 28 of steel, aluminum and/or plastic, wherein grommet 27 is used to stiffen the thin metal and distribute the load over a sufficient length to accept the fulcrum load.

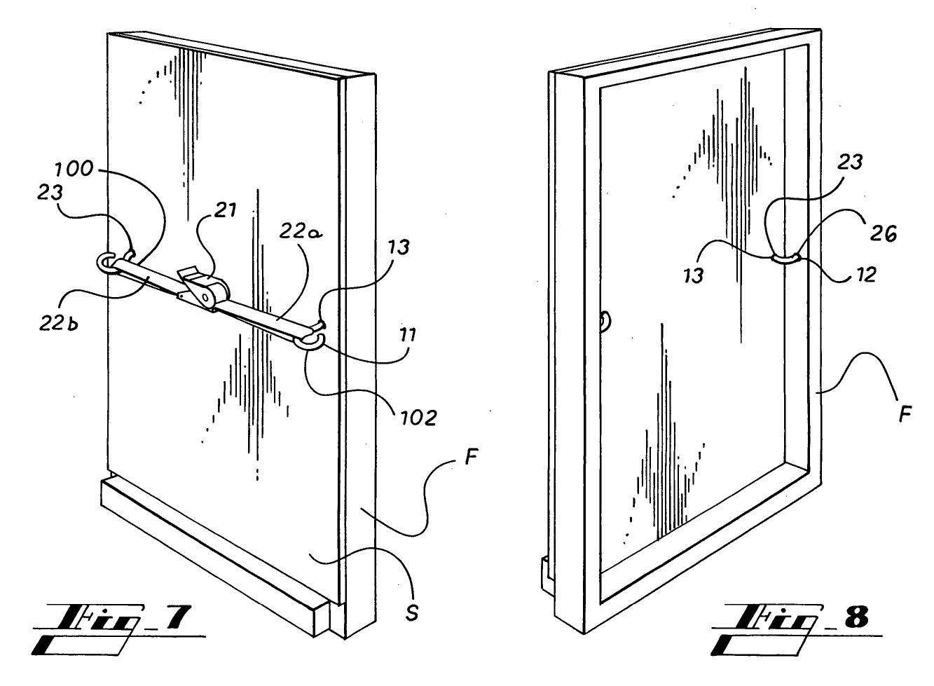

The preferred conformation and use in securing a protective covering over an opening is depicted in FIGS. 7-8, wherein FIG. 7 is a front perspective view and FIG. 8 is a rear perspective view of universal attachment assembly 20, so installed. Referring now to FIG. 8, inflection point 13 is just visible as installed proximate fulcrum hole 23, and second end 12 of clamping lever 10 bears against retainer hole 26 in opening frame F. Referring now to FIG. 7, inflection point 13 is again just visible as installed proximate fulcrum hole 23, with eyelet 102 of first end 11 of lever 10 facilitating retention of adjustable length tension assembly 100, preferably straps 22a and 22b. Thus, as ratcheting device 21 is tightened, the length of straps 22a and 22b is shortened, tension is increased, and pulling forces are exerted on first end 11 of each lever 10. At the lever fulcrum, as defined by inflection point 13, the pulling force is redirected to a compressive force, wherein compressive force delivery point 14 secures assembly 20 into retainer hole 26 of frame F. As winds shift direction, increase or decrease, and as additional tension is brought to bear on tension assembly 100, unlike introducing tensile strain on the covered structure, the present invention actually enables an increase in compressive force, and thus functionally increases the security of the covering.

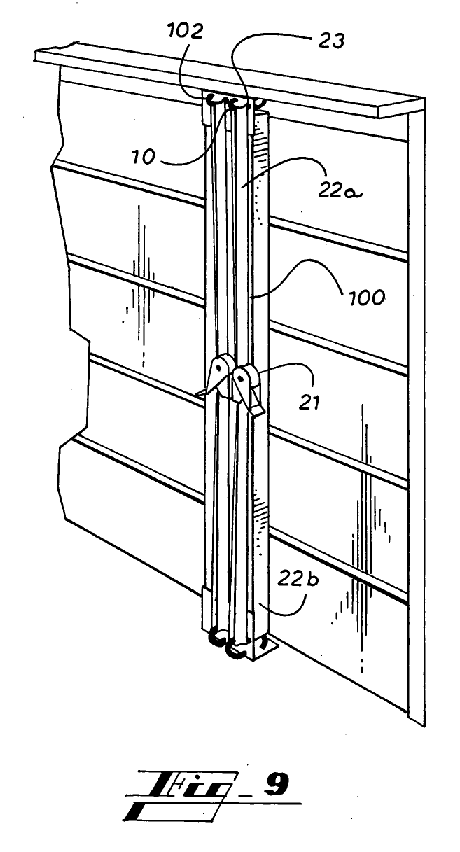

In another preferred conformation and use for attachment assembly 20, structural bracing of large span openings may be accomplished, as is depicted in FIG. 9, wherein a front perspective view of universal attachment assembly 20, as used with structural column assembly 30, is shown. Inflection point 13 of lever 10 is just visible as installed proximate fulcrum hole 23, second end 12 of clamping lever 10 bears against alignment holes 34, and eyelet 102 of first end 11 of lever 10 facilitates retention of adjustable length tension assembly 100, preferably straps 22a and 22b. Thus, as ratcheting device 21 is tightened, the length of straps 22a and 22b is shortened, tension is increased, and pulling forces are exerted on first end 11 of each lever 10. At the lever fulcrum, as defined by inflection point 13, the pulling force is redirected to a compressive force, wherein compressive force delivery point 14 secures assembly 20 into alignment hole 34 of the braced opening, here depicted as a garage door. As winds shift direction, increase or decrease, causing pressure changes to the braced garage door and/or other large span opening, wherein, for example, the garage door could be brought to bear against structural column 31, additional tension is brought to bear on tension assembly 100, and again, instead of introducing this tensile strain to structural column 31, the present invention actually enables an increase in compressive force, and thus functionally increases the security of the brace and thereby the structure of the garage door.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. An attachment assembly, comprising:
a pair of clamping levers, each said clamping lever having a first end for fixedly attaching to a tension transmitting means, a second end for engagement with a structural workpiece and an arcuately inflected midsection defined between and in the same plane as said ends, said arcuately inflected midsection defining the fulcrum of said clamping lever, and bearing against a fulcrum opening in the structural workpiece;
a tension generating and maintaining device carried between said pair of clamping levers;
a first said tension transmitting means terminated at a first end by fixedly connecting to said first end of a first said clamping lever, and terminated at a second end via adjustably connecting to said tension generating and maintaining device;
a second said tension transmitting means terminated at a first end by fixedly connecting to said first end of a second said clamping lever, and terminated at a second end by fixedly attaching to tension generating and maintaining device;
whereby each said clamping lever can be engaged to redirect, via respective fulcrums, said generated tension to compressive force, and to deliver said compressive force via said respective second ends against the respective structural workpiece.

2. A system and method for defining an attachment system, comprising the steps of:
a) obtaining a locking member capable of generating selected tensile force;
b) securing a strap member to said locking member, wherein said strap member comprises at least one piece, and wherein a first end and a second end of said strap member extend outwardly, in two opposing directions, from said locking member; and
c) securing a first class lever to said first end of said strap member and a second first class lever to said second end of said strap member, wherein each said first class lever defines an undulating profile with a centralized fulcrum defined at an inflection point, wherein each said first class lever can be utilized to change the direction of tensile forces received thereby.

3. The system and method for defining an attachment system of claim 2, further comprising the steps of:
d) obtaining a planar shield member for covering a framed opening;
e) defining a first fulcrum aperture proximate a first edge of said planar shield member and a second fulcrum aperture proximate a second edge of said planar shield member;
f) defining a first compressive force receiving point in said framed opening and a second compressive force receiving point in a relative opposing position of said frame opening;
g) positioning said planar shield member over said frame opening such that said fulcrum apertures are generally aligned with said compressive force receiving points;
h) inserting a first end of said first, first class lever through said first fulcrum aperture and into said first compressive force receiving point;
i) inserting a first end of said second, first class lever through said second fulcrum aperture and into said second compressive force receiving point; and
j) generating and locking a selected tensile force via said locking member,
wherein said strap member transfers said tensile force to said first class levers, wherein said first class levers convert said tensile force into a compressive force, wherein said compressive force is delivered to said compressive force receiving points via said first class levers, and wherein thereby said planar shield member is securely fixed across said frame opening.

4. The system and method for defining an attachment system of claim 2, further comprising the steps of:
d) obtaining an elongated structural brace for bracing a framed structure;
e) defining a first fulcrum aperture proximate a first end of said elongated structural brace and a second fulcrum aperture proximate a second end of said elongated structural brace;.
f) defining a first compressive force receiving point in said framed structure and a second compressive force receiving point in a relative vertically opposing position of said framed structure;
g) positioning said elongated structural brace vertically within said framed structure such that said fulcrum apertures are generally aligned with said compressive force receiving points;
h) inserting a first end of said first, first class lever through said first fulcrum aperture and into said first compressive force receiving point;
i) inserting a first end of said second, first class lever through said second fulcrum aperture and into said second compressive force receiving point; and
j) generating and locking a selected tensile force via said locking member,
wherein said strap member transfers said tensile force to said first class levers, wherein said first class levers convert said tensile force into a compressive force, wherein said compressive force is delivered to said compressive force receiving points via said first class levers, and wherein thereby said elongated structural brace is securely and vertically fixed braced within said framed structure.

5. The system and method of claim 4, wherein each end of said elongated structural brace carries an L-profile adapter plate, wherein the short arm of said “L” profile of said adapter plate is perpendicular to the length of said elongated structural brace and is coplanar with an end of said elongated structural brace, wherein a portion of the long arm of said “L” profile of said adapter plate is exposed between said end of said elongated structural brace and said short arm of said “L” profile of said adapter plate, and wherein said fulcrum apertures are defined in said exposed portion of said long arm of said “L” profile of each said adapter plate.

6. The system and method of claim 5, wherein a lever receiving resistance point is defined in each said short arm of said “L” profile of each said adapter plate, and wherein said lever receiving resistance point is in alignment with said fulcrum aperture.

7. The system and method of claim 4, wherein said braced framed structure is a garage door.

8. The system and method of claim 5, wherein said “L”-shaped adapter plate is integrally formed with said elongated structural brace.

9. A method of installing a hurricane shutter over a window, comprising the steps of:
a) selecting a window for protection, said window having a frame with a casement inner surface;
b) defining a first compression receipt aperture in said casement inner surface of said window frame;
c) defining a second compression receipt aperture in said casement inner surface of said window frame, said second aperture opposing positioned relative to said first aperture;
d) obtaining a hurricane shutter;
e) defining a first throughhole in said hurricane shutter, proximate an outer edge thereof, and in a position facilitating alignment with said first compression receipt aperture in said window frame when said hurricane shutter is installed;
f) defining a second throughole in said hurricane shutter, proximate an outer edge thereof, opposing said outer edge of said first throughhole, and in a position facilitating alignment with said second compression receipt aperture in said window frame when said hurricane shutter is installed;
g) obtaining a ratcheting clamp with a flexible member extending bi-directionally therefrom;
h) securing each free end of said flexible member to a lever;
i) placing a first end of said first lever through said first throughhole in said hurricane shutter;
j) extending said first end of said first lever into said first compression receipt aperture in said window frame;
k) placing a first end of said second lever through said second throughhole in said hurricane shutter;
l) extending said first end of said second lever into said second compression receipt aperture in said window frame; and
m) tightening said ratcheting clamp.

10. A multi-arced lever that facilitates the directional change of a tensile force to that of a compressive force, comprising:
an eyelet defined proximate a first end, said eyelet adapted for attachment to an adjustable tensioning assembly and receipt of a tensile force;
a second end adapted for delivery of a compressive force; and
a central inflection point, reversed in concavity relative to said first and second end arcs and adapted for fulcrum function.

11. An attachment assembly system and method utilizing a pair of multi-arced levers as defined in claim 10, comprising:
a tension delivery member for delivering a tensile pulling force to each said lever; and
a tension adjustment member,
wherein the tensile pulling force delivered to each said lever is directionally changed into a compressive force, thereby securely placing and seating said universal attachment assembly in a selected position relative to a workpiece via compressive force delivery.

12. The attachment assembly system and method of claim 11, wherein said second end of each said lever is extended through a fulcrum hole in the workpiece covering, toward the interior of the workpiece opening frame, and preferably brought to bear on a retainer hole defined in said workpiece opening frame, wherein said compressive force effectively secures the workpiece covering over the workpiece opening frame.

13. The attachment assembly system and method of claim 12, wherein the load point of said fulcrum hole is located proximate the outer edge of the workpiece opening frame relative to a line of centers through the load points of said two ends of said lever.

14. The multi-arced lever of claim 10, wherein said lever is formed by a process selected from the group comprising rod bending, stamping, or forging.

15. The attachment assembly system and method of claim 11, wherein said tension adjustment member is selected from the group comprising a ratchet, prong buckle, frictional engagement buckle, loop engaging ring, locking extendable and retractable device, or cinch.

16. The attachment assembly system and method of claim 11, wherein said tension delivery member is selected from a group comprising straps, rope, wire, spring, or hydraulic cylinder.
